(19) United States
(12) Patent Application Publication
(10) Pub. No.: US 2022/0041933 A1
(43) Pub. Date: Feb. 10, 2022

(54) LIQUID CRYSTAL COMPOSITION, LIQUID CRYSTAL DISPLAY ELEMENT AND LIQUID CRYSTAL DISPLAY

(71) Applicant: Shijiazhuang Chengzhi Yonghua Display Material Co., Ltd., Shijiazhuang, Hebei (CN)

(72) Inventors: Kui WANG, Shijiazhuang, Hebei (CN); Sumin KANG, Shijiazhuang, Hebei (CN); Zhian LIANG, Shijiazhuang, Hebei (CN); Guoliang YUN, Shijiazhuang, Hebei (CN); Hongfeng LI, Shijiazhuang, Hebei (CN); Jiaming LI, Shijiazhuang, Hebei (CN); Ruixiang LIANG, Shijiazhuang, Hebei (CN)

(21) Appl. No.: 17/271,523

(22) PCT Filed: Nov. 18, 2020
(86) PCT No.: PCT/CN2020/129884

§ 371 Date: Feb. 25, 2021

(30) Foreign Application Priority Data
Dec. 30, 2019 (CN) 201911394897.X

(51) Int. Cl. C09K 19/44; C09K 19/32; C09K 19/30

(52) U.S. Cl. CPC C09K 19/44; C09K 19/32; C09K 19/3028; C09K 2019/122; C09K 2019/3016; C09K 2019/301; C09K 2019/3036; C09K 19/3048

(57) ABSTRACT

The invention relates to a liquid crystal composition, a liquid crystal display element and a liquid crystal display comprising the liquid crystal composition, belonging to the field of liquid crystal display. The liquid crystal composition of the present disclosure comprises a compound of formula I and one or more compounds of formula II. The liquid crystal composition can increase the dielectric anisotropy and improve the voltage retention rate.

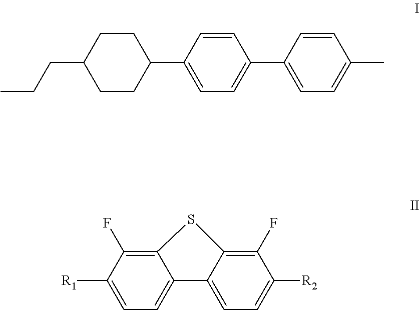

### TECHNICAL FIELD

The present disclosure belongs to the field of liquid crystal display, in particular to a liquid crystal composition and a liquid crystal display element or liquid crystal display containing the liquid crystal composition.

### BACKGROUND ART

Display is the process of transforming electrical signal (data information) into visible light (visual information), flat panel display (FPD) is the most popular display device now. Liquid crystal display (LCD) is the first product developed and commercialized in FPD. At present, thin film transistor liquid crystal (TFT-LCD) has become the mainstream product in LCD application.

The development of TFT-LCD has gone through a long period of basic research. After the realization of mass production and commercialization, TFT-LCD products are rapidly recognized by the market for their advantages of light weight, environmental protection and high performance, and gradually develop to large-scale and multi-type applications. The application of TFT-LCD can be seen everywhere, whether it is a small-sized mobile phone screen, a large-scale Notebook PC or monitor, and a large-scale LCD TV (LCDTV). TFT-LCD can be divided into three types, twisted nematic/super twisted nematic (TN/STN), planar conversion (IPS) and vertical alignment (VA). The early commercial TFT-LCD products basically adopt twisted nematic (TN) display mode, the biggest problem is that the viewing angle is not large enough. With the increase of the size of TFT-LCD products, especially the application of TFT-LCD in the field of TV, the in-plane switching (IPS) display mode with wide field of view has been developed and applied. IPS display mode is first published in 1974 by american R. Soref in the form of a paper, and is proposed by german G. Baur to apply it as a wide perspective technology in TFT-LCD. In 1995, Hitachi of Japan developed the world's first 13.3-inch IPS wide field angle TFT-LCD product.

Compared with other kinds of liquid crystal displays, VA type liquid crystal display has a very high contrast, because in the dark state without power on, the liquid crystal molecules are arranged perpendicular to the surface of the substrate, without any phase difference, extremely low light leakage, low dark brightness and high contrast, which makes it widely used in large-scale display, such as television and so on. However, in the existing technology, the LCD response speed is not fast enough, the threshold voltage is not low enough, the voltage retention rate is not high enough, the ion density is not low, and the display yield rate is low, which has become the main obstacle for the LCD to achieve higher performance specifications. Improving the above indicators is also the goal that all device manufacturers have been pursuing.

### SUMMARY OF THE INVENTION

In order to solve the problems existing in the prior art, the inventors and others found that the dielectric anisotropy of the liquid crystal material can be increased and the voltage retention rate can be improved by using the liquid crystal composition of the present disclosure.

Another object of the present disclosure is to provide a liquid crystal display element comprising a liquid crystal composition of the present disclosure, which has a fast response speed.

A further object of the present disclosure is to provide a liquid crystal display comprising a liquid crystal composition of the present disclosure, which has a fast response speed.

To achieve the above purpose, the present disclosure adopts the following technical solutions:

A liquid crystal composition comprising a compound of formula I and one or more compounds of formula II is provided,

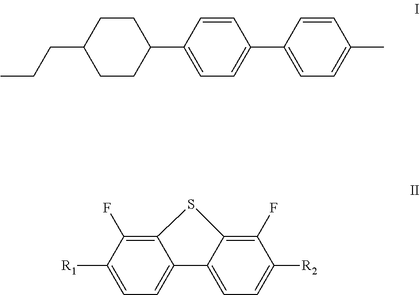

in formula II, R₁ represents an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10; any one —CH₂— or several —CH₂— that are not adjacent of the group indicated by R₁ are selectively substituted by cyclopentyl, cyclobutyl or cyclopropyl;

R₂ represents an alkyl group having a carbon atom number of 1-10, a fluoro-substituted alkyl group having a carbon atom number of 1-10, an alkoxy group having a carbon atom number of 1-10, or a fluoro-substituted alkoxy group having a carbon atom number of 1-10.

The present disclosure also provides a liquid crystal display element comprising a liquid crystal composition of the present disclosure, the liquid crystal display element is an active matrix addressing display element or a passive matrix addressing display element.

The present disclosure also provides a liquid crystal display comprising a liquid crystal composition of the present disclosure, the liquid crystal display is an active matrix addressing display or a passive matrix addressing display.

### Effect of Invention

The beneficial effect of the present disclosure is that the liquid crystal composition has large dielectric anisotropy of liquid crystal material and high voltage retention rate. The liquid crystal display element and the liquid crystal display containing the liquid crystal composition have fast response speed, thereby realizing the effect of improving the performance of the liquid crystal display.

### DETAILED DESCRIPTION OF EMBODIMENTS

### [Liquid Crystal Composition]

The liquid crystal composition of the present disclosure comprises a compound of formula I and one or more compounds of formula II,

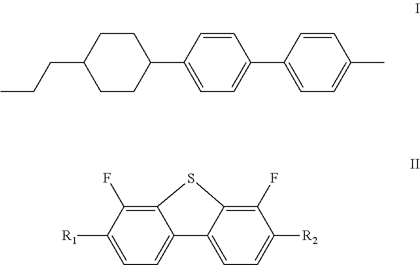

in formula II, R₁ represents an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10; any one —CH₂— or several —CH₂— that are not adjacent of the group indicated by R₁ are selectively substituted by cyclopentyl, cyclobutyl or cyclopropyl; for example, 1,2-cyclopentyl, 1,3-cyclopentyl, 1,2-cyclobutyl, 1,3-cyclobutyl;

R₂ represents an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10.

The liquid crystal composition can increase the dielectric anisotropy and improve the voltage retention rate. The liquid crystal display element and liquid crystal display containing the liquid crystal composition have low driving voltage and fast response speed.

For example, methyl, ethyl, n-propyl, isopropyl, n-butyl, isobutyl, tert butyl, n-amyl, isoamyl, hexyl, heptyl, octyl, nonyl, decyl, etc. can be listed as the alkyl groups with carbon atom number of 1-10.

For example, methoxy, ethoxy, n-propoxy, isopropoxy, n-butoxy, isobutoxy, pentoxy, hexoxy, hepthoxy, octyloxy, nonoxy, decaoxy, etc. can be listed as the alkoxy groups with the carbon atom number of 1-10.

The “fluoro-substituted” in the fluoro-substituted alkyl group having a carbon atom number of 1-10, fluoro-substituted alkenyl group having a carbon atom number of 2-10 can be single fluorine substitution, or multi fluorine substitution, such as difluoro substitution and trifluoro substitution, or perfluoro substitution. There is no special algebra for fluorine limitation. For example, fluoromethyl, difluoromethyl, trifluoromethyl, 1-fluoroethyl, 2-fluoroethyl, 1,2-difluoroethyl, 1,1-difluoroethyl, 1,1,2-trifluoroethyl, 1,1,1,2,2-pentafluoroethyl, etc. can be listed as the fluoro-substituted alkyl group having a carbon atom number of 1-10, but not limited to.

In the liquid crystal composition of the present disclosure, the compounds of formula II are preferably selected from the group consisting of the compounds of the following formula II-1-II-6:

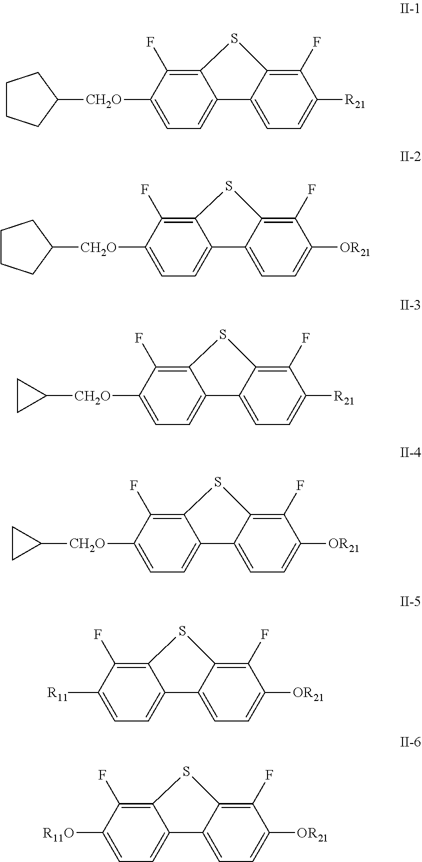

wherein, R₁₁, R₂₁ represents an alkyl group having a carbon atom number of 1-10.

The liquid crystal composition of the present disclosure preferably also comprises one or more compounds of formula III:

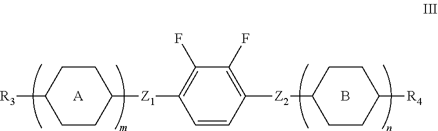

in formula III, R₃ and R₄ independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8, or a fluoro-substituted alkenoxy group having a carbon atom number of 3-8;

any one —CH₂— or several —CH₂— that are not adjacent of the groups indicated by R₃ and R₄ are selectively substituted by cyclopentyl, cyclobutyl or cyclopropyl;

for example, 1,2-cyclopentyl, 1,3-cyclopentyl, 1,2-cyclobutyl, 1,3-cyclobutyl can be listed as the cyclopentyl, cyclobutyl mentioned above;

Z₁ and Z₂ independently represent single bond, —CH₂CH₂—, —OCH₂— or —CH₂O—;

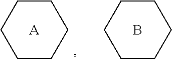

independently represent 1,4-cyclohexylidene, 1,4-cyclohexenylene, 1,4-phenylene or fluoro 1,4-phenylene;

in represents 0 or 1; n represents 0, 1 or 2.

The compound of formula III has negative dielectric anisotropy, and the driving voltage of the liquid crystal composition can be adjusted by containing the compound of formula III in the liquid crystal composition of the present disclosure.

In the liquid crystal composition of the present disclosure, the compounds of formula III are preferably selected from the group consisting of the compounds of the following formula III-1-III-11:

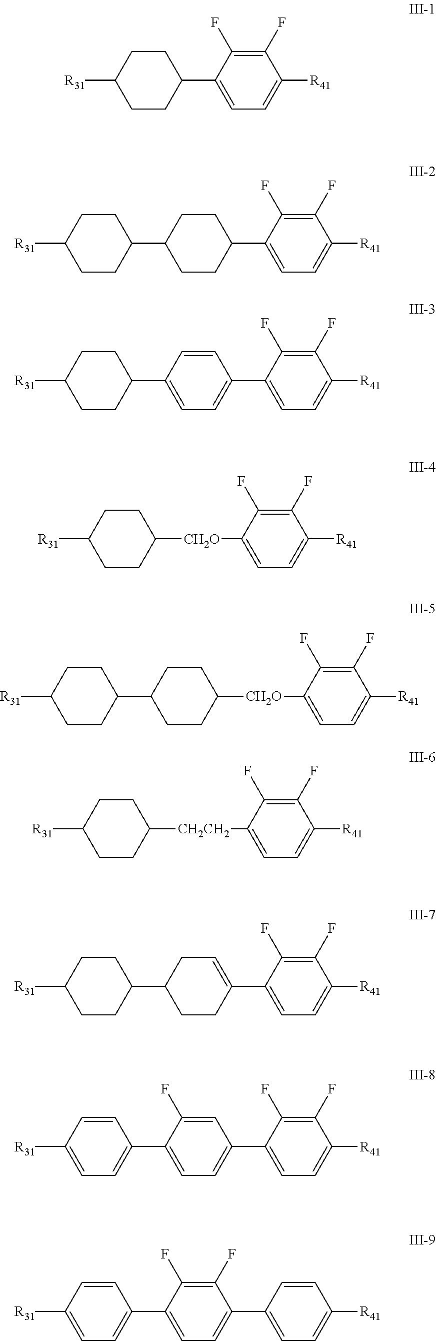

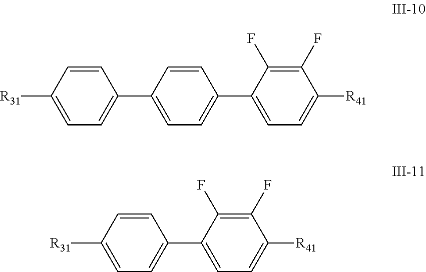

wherein:

R₃₁ and R₄₁ independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8 or a fluoro-substituted alkenoxy group having a carbon atom number of 3-8;

any one —CH₂— or several —CH₂— that are not adjacent of the groups indicated by R₃₁ and R₄₁ are selectively substituted by cyclopentyl, cyclobutyl or cyclopropyl;

for example, 1,2-cyclopentyl, 1,3-cyclopentyl, 1,2-cyclobutyl, 1,3-cyclobutyl can be listed as the cyclopentyl, cyclobutyl mentioned above.

The liquid crystal composition of the present disclosure preferably also comprises one or more compounds of formula IV:

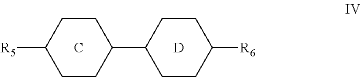

wherein,

R₅ and R₆ independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10;

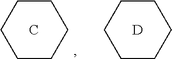

independently represent 1,4-cyclohexylidene, 1,4-cyclohexenylene or 1,4-phenylene.

By containing the compound of formula IV in the liquid crystal composition of the present disclosure, the mutual solubility of the liquid crystal composition can be reduced, and the rotational viscosity can be reduced, so as to improve the response speed of the liquid crystal composition of the present disclosure.

The liquid crystal composition of the present disclosure, preferably, the compounds of formula IV are selected from the group consisting of the following compounds of formula IV-1-IV-3:

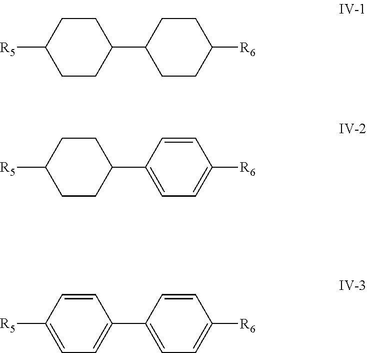

wherein,

R₅ and R₆ represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10.

The liquid crystal composition of the present disclosure preferably comprises one or more compounds of formula V except for those compound of formula I:

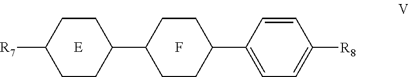

wherein, R₇ and R₈ independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10;

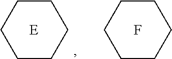

independently represent 1,4-cyclohexylidene, 1,4-cyclohexenylene or 1,4-phenylene.

By containing the compound of formula V in the liquid crystal composition of the present disclosure, the optical anisotropy of the liquid crystal composition can be increased and the clearing point of the liquid crystal composition can be improved, which is conducive to improving the response speed of the liquid crystal composition.

In the liquid crystal composition of the present disclosure, it is preferred that the compounds of formula V other than those in formula I are selected from the group consisting of the compounds of formula V-1-V-3 as follows:

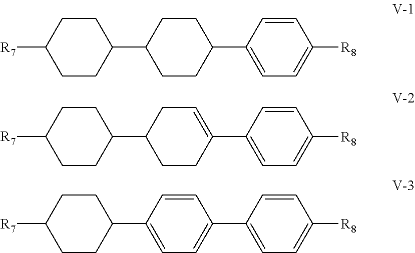

wherein,

R₇ and R₈ independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10.

The liquid crystal composition of the present disclosure preferably also comprises one or more compounds of formula VI:

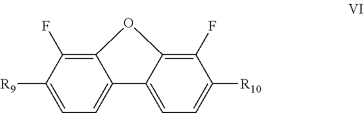

wherein,

R₉ represents an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, any one —CH₂— or several —CH₂— that are not adjacent of the group indicated by R₉ are selectively substituted by cyclopentyl, cyclobutyl or cyclopropyl;

for example, 1,2-cyclopentyl, 1,3-cyclopentyl, 1,2-cyclobutyl, 1,3-cyclobutyl can be listed as the cyclopentyl, cyclobutyl mentioned above;

R₁₀ represents an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10.

By containing the compound of formula VI in the liquid crystal composition of the present disclosure, the liquid crystal composition can have large negative dielectric anisotropy, which is conducive to reducing the driving voltage of the device.

The liquid crystal composition of the present disclosure, preferably, the compounds of the formula VI are selected from the group consisting of the compounds of the following formula VI-1-VI-6:

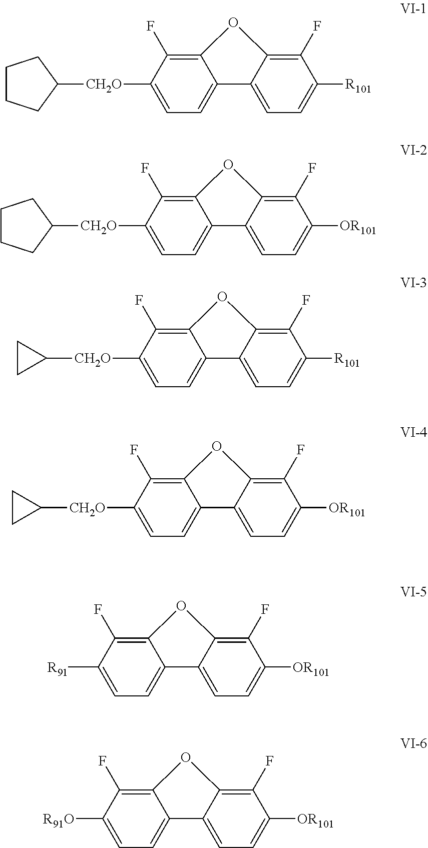

wherein, R₉₁ and R₁₀₁ independently represent an alkyl group having a carbon atom number of 1-10.

In the liquid crystal composition of the present disclosure, the addition amount (mass ratio) of the compound of formula I in the liquid crystal composition is 1-15%, preferably 3-11%; the addition amount (mass ratio) of the compound of formula II in the liquid crystal composition is 1-30%, preferably 8-20%; the addition amount (mass ratio) of the compound of formula III in the liquid crystal composition is 0-50%, preferably 20-40%; and the addition amount (mass ratio) of the compound of formula IV in the liquid crystal composition is 0-60%, preferably 35-50%; the addition amount (mass ratio) of the compound of formula V in the liquid crystal composition is 0-35%, preferably 12-25%; the addition amount (mass ratio) of the compound of formula VI in the liquid crystal composition is 0-10%.

In the liquid crystal composition of the present disclosure, dopants with various functions can be added. In the case of dopants, the content of dopants preferably accounts for 0.01-1.5% of the liquid crystal composition by mass. These dopants can be listed as antioxidants, ultraviolet absorbers and chiral agents.

Antioxidants can be listed as,

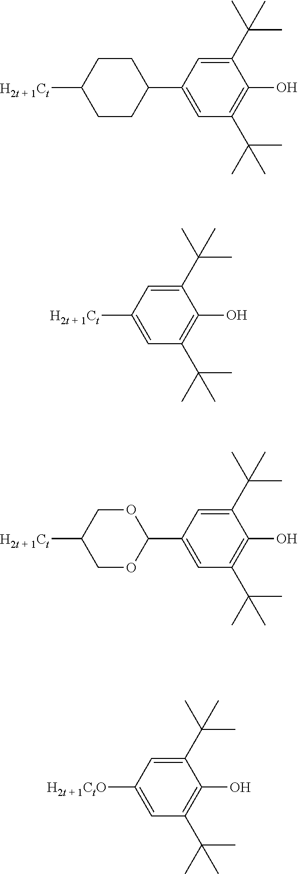

t represents an integer of 1-10;

chiral agents can be listed as,

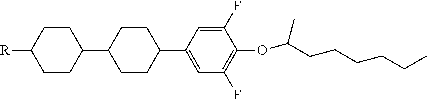

R represents an alkyl group having a carbon atom number of 1-10;

light stabilizers can be listed as,

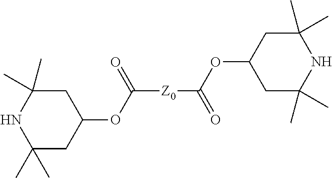

Z₀ represents an alkylene group having a carbon atom number of 1-20, in which any one or more hydrogen is selectively substituted by halogen, and any one or more —CH₂— is selectively substituted by —O—;

ultraviolet absorbers can be listed as,

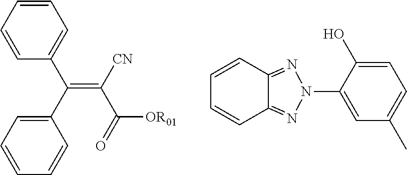

R₀₁ represents an alkyl group having a carbon atom number of 1-10.

### [Liquid Crystal Display Element or Liquid Crystal Display]

The present disclosure also relates to a liquid crystal display element or a liquid crystal display comprising any one of the above liquid crystal compositions; the display element or display is an active matrix display element or display or a passive matrix display element or display.

Alternatively, the liquid crystal display element or liquid crystal display preferably has an active matrix liquid crystal display element or a liquid crystal display.

Alternatively, the active matrix display element or display is IPS-TFT, FFS-TFT, VA-TFT liquid crystal display element or display.

The liquid crystal display element or liquid crystal display comprising the compound or liquid crystal composition has low driving voltage, high voltage retention rate and fast response speed.

### EMBODIMENTS

In order to explain the present disclosure more clearly, the present disclosure will be further explained in combination with the preferred embodiment. Those skilled in the art should understand that the contents described below are illustrative rather than restrictive, and the scope of protection of the present disclosure should not be limited.

In this manual, unless otherwise specified, the percentage refers to the mass percentage, and the temperature is degree centigrade (° C.). The specific meaning and test conditions of other symbols are as follows:

Cp is the clear point (° C.) of liquid crystal, and it is measured by DSC quantitative method;

Δ n is the optical anisotropy, no is the refractive index of ordinary light, Ne is the refractive index of extraordinary light, the test conditions are 25+2° C., 589 nm, Abbe refractometer test;

Δε is the dielectric anisotropy, Δε=ε_{∥}-ε_{⊥}, where ε_{∥} is the dielectric constant parallel to the molecular axis, and ε_{⊥} is the dielectric constant perpendicular to the molecular axis. The test conditions are 25±0.5° C., 20 um vertical box, INSTEC:ALCT-IR1 testing;

γ₁ is the rotational viscosity (mPa·s), and the test conditions are 25±0.5° C. and 20 um vertical box, INSTEC:ALCT-IR1 testing;

K₁₁ is the torsional elastic constant and K₃₃ is the unfolding elastic constant INSTEC:ALCT-IR1, 20 um vertical box;

the prep comparative example method of the liquid crystal composition is as follows: each liquid crystal monomer is weighed according to a certain proportion and put into a stainless steel beaker; the stainless steel beaker containing each liquid crystal monomer is heated and melted on the magnetic stirring instrument; after most of the liquid crystal monomer in the stainless steel beaker is melted, a magnetic rotor is added into the stainless steel beaker, and the mixture is stirred evenly and cooled to room temperature to obtain liquid crystal composition.

The structure of liquid crystal monomer in the embodiment of the disclosure is represented by codes. The codes for ring structures, end groups and linking groups of liquid crystals are represented as in Table 1 and Table 2 below.

TABLE 1
corresponding codes of ring structure

| Ring structure | Corresponding code |
|---|---|
| 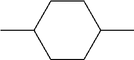 | C |
| 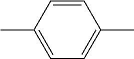 | P |
| 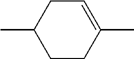 | L |
| 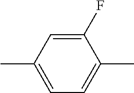 | G |
| 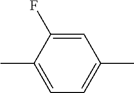 | Gi |
| 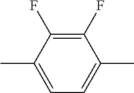 | Y |
| 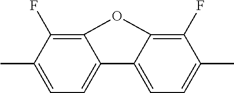 | Sb |
| 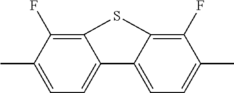 | Sc |

TABLE 2
corresponding codes of end group and linking group

| End group and linking group | Corresponding code |
|---|---|
| CₙH₂ₙ₊₁— | n— |
| CₙH₂ₙ₊₁O— | nO— |
| —CF₃ | —T |
| —OCF₃ | —OT |
| —CH₂O— | —O— |
| —F | —F |
| —CH₂CH₂— | —E— |
| —CH═CH— | —V— |
| —CH═CH—CₙH₂ₙ₊₁ | Vn— |
| 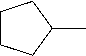 | Cp— |
| 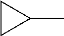 | Cpr— |
| 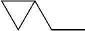 | Cpr1— |
| 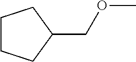 | CpO |
| 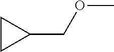 | CprO |

### EXAMPLES

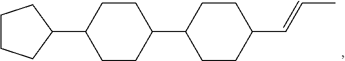 [SMILES: C/C=C/C1CCC(C2CCC(C3CCCC3)CC2)CC1]

the code is CC-Cp-V1;

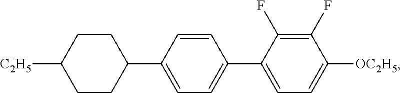 [SMILES: CCOc1ccc(-c2ccc(C3CCC(CC)CC3)cc2)c(F)c1F]

the code is CPY-2-O2;

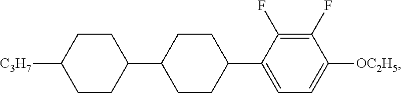

the code is CCY-3-O2;

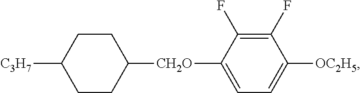

the code is COY-3-O2;

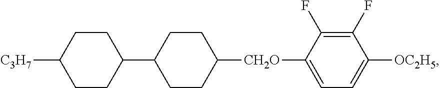

the code is CCOY-3-O2;

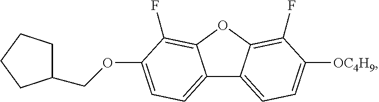

the code is Sb-CpO-O4;

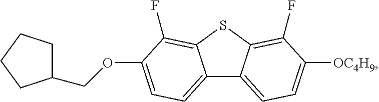

the code is Sc-CpO-O4.

### Example 1

The formula and corresponding properties of the liquid crystal composition are shown in Table 3.

TABLE 3
Formula and corresponding properties of liquid crystal
composition in example 1

| Category | Liquid crystal monomer code | Content (mass fraction) |
|---|---|---|
| I | CPP-3-1 | 15 |
| II | Sc-CpO-O4 | 10 |
| II | Sc-CpO-O2 | 9 |
| II | Sc-2O-O4 | 10 |
| IV | CC-3-V | 35 |
| IV | CP-3-O2 | 8 |
| IV | PP-5-O2 | 7 |
| IV | CC-2-3 | 6 |

Δε[1 KHz, 25° C.]: −3.0
Δn[589 nm, 25° C.]: 0.118
Cp: 70° C.
γ₁: 58 mPa · s
K₁₁: 13.0
K₃₃: 12.1

### Example 2

The formula and corresponding properties of the liquid crystal composition are shown in Table 4.

TABLE 4
Formula and corresponding properties of
liquid crystal composition in example 2

| Category | Liquid crystal monomer code | Content (mass fraction) |
|---|---|---|
| I | CPP-3-1 | 13.5 |
| II | Sc-CpO-O4 | 9 |
| II | Sc-CpO-O2 | 9 |
| II | Sc-2O-O4 | 6 |
| III | CPY-3-O2 | 7 |
| III | CPY-2-O2 | 8 |
| IV | CC-3-V | 23.5 |
| IV | CC-2-3 | 19 |
| IV | PP-5-1 | 5 |

Δε[1 KHz, 25° C.]: −3.4
Δn[589 nm, 25° C.]: 0.119
Cp: 74° C.
γ₁: 71 mPa · s
K₁₁: 12.7
K₃₃: 13.0

### Example 3

The formula and corresponding properties of the liquid crystal composition are shown in Table 5.

TABLE 5
Formula and corresponding properties of liquid
crystal composition in example 3

| Category | Liquid crystal monomer code | Content (mass fraction) |
|---|---|---|
| I | CPP-3-1 | 10 |
| II | Sc-CpO-O4 | 7 |
| II | Sc-CpO-O2 | 9 |
| III | CCOY-3-O2 | 9 |
| III | CY-3-O2 | 7 |
| IV | CC-2-3 | 22 |
| IV | CC-4-3 | 7 |
| IV | CC-5-3 | 5 |
| IV | CP-3-O2 | 7 |
| V | CPP-3-2 | 8 |
| V | CCP-V-1 | 9 |

Δε[1 KHz, 25° C.]: −2.8
Δn[589 nm, 25° C.]: 0.103
Cp: 83° C.
γ₁: 76 mPa · s
K₁₁: 14.2
K₃₃: 13.4

### Example 4

The formula and corresponding properties of the liquid crystal composition are shown in Table 6.

TABLE 6
Formula and corresponding properties of liquid
crystal composition in example 4

| Category | Liquid crystal monomer code | Content (mass fraction) |
|---|---|---|
| I | CPP-3-1 | 7.5 |
| II | Sc-CpO-O4 | 7 |
| II | Sc-CpO-O2 | 5 |
| III | CY-3-O2 | 7 |
| III | CY-3-O4 | 7 |
| III | CCY-3-O2 | 9 |
| IV | CC-3-V | 29.9 |
| IV | CP-3-O2 | 5 |
| IV | CC-4-3 | 5 |
| V | CCP-V-1 | 7 |
| V | CPP-3-2V1 | 5 |
| VI | ZSb-CpO-O4 | 5.6 |

Δε[1 KHz, 25° C.]: −3.0
Δn[589 nm, 25° C.]: 0.100
Cp: 73° C.
γ₁: 70 mPa · s
K₁₁: 12.2
K₃₃: 13.4

### Comparative Example 1

The formula and corresponding properties of the liquid crystal composition are shown in Table 7.

TABLE 7
Formula and corresponding properties of liquid crystal
composition in Comparative Example 1

| Category | Liquid crystal monomer code | Content (mass fraction) |
|---|---|---|
| I | CPP-3-1 | 7.5 |
| | PY-2O-O2 | 7 |
| | PY-3-O2 | 5 |
| III | CY-3-O2 | 7 |
| III | CY-3-O4 | 7 |
| III | CCY-3-O2 | 9 |
| IV | CC-3-V | 29.9 |
| IV | CP-3-O2 | 5 |
| IV | CC-4-3 | 5 |
| V | CCP-V-1 | 7 |
| V | CPP-3-2V1 | 5 |
| VI | Sb-CpO-O4 | 5.6 |

Δε[1 KHz, 25° C.]: −2.6
Δn[589 nm, 25° C.]: 0.099
Cp: 68° C.
γ₁: 70 mPa · s
K₁₁: 11.1
K₃₃: 12.5

The Sc-CpO-O4 and Sc-CpO-O2 in Example 4 were replaced with PY-2O-O2 and PY-3-02, respectively, and the rest were the same as in Example 4, which served as Comparative Example 1. Compared with Comparative Example 1, the liquid crystal composition of Example 4 has a large dielectric anisotropy (Δε) and a high clearing point (Cp), and can be used to develop a large dielectric wide temperature display liquid crystal display.

TABLE 8
Reliability data of example and comparative example

| | VHR (initial)/ | VHR (UV)/ | VHR (Heat)/ |
|---|---|---|---|
| Experiment number | % | % | % |
| Example 4 | 96.65 | 95.59 | 96.55 |
| Comparative Example 1 | 93.45 | 90.25 | 89.55 |

The reliability of the liquid crystal composition was tested by UV, high temperature aging test and VHR test.

The smaller the change in the VHR data of the liquid crystal composition before and after UV and high temperature tests, the stronger the UV and high temperature resistance. Therefore, the UV resistance and high temperature resistance are judged by comparing the difference of the VHR data of each embodiment and comparative example before and after the test.

First, before the UV and high temperature aging test, the VHR data of the liquid crystal composition is measured as the initial VHR data, then the UV and high temperature aging test is performed on the liquid crystal composition, and the VHR data of the liquid crystal composition is measured again after the test.

Ultraviolet aging test: The liquid crystal composition is placed under an ultraviolet lamp with a wavelength of 365 nm and irradiated with energy of 5000 mJ.

High temperature aging test: place the liquid crystal composition in an oven at 100° C. for one hour.

After the aging test, the smaller the change of the VHR data relative to the initial VHR data, the stronger the ability of the liquid crystal composition to resist ultraviolet and high temperature, so that it can be judged that the liquid crystal composition has a stronger ability to resist external environmental damage during the working process. Therefore, the reliability of the liquid crystal composition is higher.

In addition, the liquid crystal compositions of Example 4 and Comparative Example 1 were poured into a liquid crystal test box, and an afterimage test was performed. The test results are shown in Table 8 above.

It can be seen from Table 8 that the UV resistance and high temperature resistance of the liquid crystal composition of the present invention are very obvious. This shows that the liquid crystal composition of the present invention has good UV resistance and high temperature resistance.

### Example 5

The formula and corresponding properties of the liquid crystal composition are shown in Table 9.

TABLE 9
Formula and corresponding properties of liquid crystal
composition in example 5

| Category | Liquid crystal monomer code | Content (mass fraction) |
|---|---|---|
| I | CPP-3-1 | 5 |
| II | Sc-CpO-O2 | 5 |
| II | Sc-CpO-O4 | 3 |
| III | CY-3-O2 | 10.5 |
| III | CCOY-3-O2 | 5 |
| III | PY-2O-O2 | 5 |
| III | CPY-3-O2 | 7.5 |
| IV | CC-3-V | 19.5 |
| IV | CC-2-3 | 15 |
| IV | PP-5-1 | 5 |
| V | CPP-3-2 | 8 |
| V | CPP-1V-2 | 7 |
| VI | Sb-CpO-O4 | 4.5 |

Δε[1 KHz, 25° C.]: −3.1
Δn[589 nm, 25° C.]: 0.116
Cp: 71° C.
γ₁: 68 mPa · s
K₁₁: 12.8
K₃₃: 11.9

### Example 6

The formula and corresponding properties of the liquid crystal composition are shown in Table 10.

TABLE 10
Formula and corresponding properties of liquid crystal
composition in example 6

| Category | Liquid crystal monomer code | Content (mass fraction) |
|---|---|---|
| I | CPP-3-1 | 11.5 |
| II | Sc-2O-O4 | 5 |
| III | PY-3-O2 | 5 |
| III | LY-Cp-O2 | 3 |
| III | CPY-3-O2 | 7 |
| III | CPY-2-O2 | 9 |
| III | COY-3-O2 | 11 |
| IV | CC-3-V | 25 |
| IV | CC-4-3 | 5 |
| IV | CC-5-3 | 7 |
| V | CCP-V2-1 | 7 |
| VI | Sb-2O-O5 | 4.5 |

Δε[1 KHz, 25° C.]: −3.3
Δn[589 nm, 25° C.]: 0.108
Cp: 78° C.
γ₁: 76 mPa · s
K₁₁: 12.5
K₃₃: 14.9

### Example 7

The formula and corresponding properties of the liquid crystal composition are shown in Table 11.

TABLE 11
Formula and corresponding properties of liquid crystal
composition in example 7

| Category | Liquid crystal monomer code | Content (mass fraction) |
|---|---|---|
| I | CPP-3-1 | 9.5 |
| II | Sc-CpO-O4 | 9 |
| II | Sc-CpO-O2 | 9 |
| III | CY-3-O2 | 13.5 |
| III | CY-5-O2 | 15.5 |
| III | CY-3-O4 | 9.5 |
| V | CCP-V-1 | 11.5 |
| V | CCP-V2-1 | 9.5 |
| V | CPP-3-2 | 8 |
| V | CCP-3-1 | 5 |

Δε[1 KHz, 25° C.]: −3.6
Δn[589 nm, 25° C.]: 0.117
Cp: 83° C.
γ₁: 90 mPa · s
K₁₁: 11.9
K₃₃: 13.7

### Example 8

The formula and corresponding properties of the liquid crystal composition are shown in Table 12.

TABLE 12
Formula and corresponding properties of liquid crystal
composition in example 8

| Category | Liquid crystal monomer code | Content (mass fraction) |
|---|---|---|
| I | CPP-3-1 | 5.5 |
| II | Sc-2O-O4 | 9 |
| III | CY-3-O2 | 15.5 |
| III | CY-5-O2 | 16 |
| III | CCY-3-O3 | 5 |
| III | PY-3-O2 | 10.5 |
| V | CCP-V-1 | 10.5 |
| V | CCP-V2-1 | 10 |
| V | CPP-1V-2 | 7.5 |
| V | CPP-5-2 | 4.5 |
| VI | Sb-2O-O5 | 6 |

Δε[1 KHz, 25° C.]: −4.0
Δn[589 nm, 25° C.]: 0.125
Cp: 79° C.
γ₁: 91 mPa · s
K₁₁: 11.7
K₃₃: 12.9

### Example 9

The formula and corresponding properties of the liquid crystal composition are shown in Table 13.

TABLE 13
Formula and corresponding properties of liquid
crystal composition in example 9

| Category | Liquid crystal monomer code | Content (mass fraction) |
|---|---|---|
| I | CPP-3-1 | 3 |
| II | Sc-CpO-O4 | 10 |
| II | Sc-CpO-O2 | 9 |
| IV | CC-3-V | 33 |
| IV | CC-2-3 | 15 |
| V | CPP-3-2 | 8 |
| V | CPP-1V-2 | 5.5 |
| V | CPP-3-2V1 | 9 |
| VI | Sb-CpO-O4 | 7.5 |

Δε[1 KHz, 25° C.]: −2.9
Δn[589 nm, 25° C.]: 0.113
Cp: 76° C.
γ₁: 61 mPa · s
K₁₁: 13.9
K₃₃: 11.9

Obviously, the above-mentioned examples of the present disclosure are only for the purpose of clearly explaining the examples of the present disclosure, rather than limiting the implementation mode of the present disclosure. For ordinary technical personnel in the art, other changes or changes in different forms can be made on the basis of the above description. Here, it is impossible to enumerate all the examples, and all the technologies belong to the present disclosure The obvious changes or changes in the technical scheme are still within the scope of protection of the present disclosure.

1. A liquid crystal composition, wherein that the liquid crystal composition comprises a compound of formula I and one or more compounds of formula II, 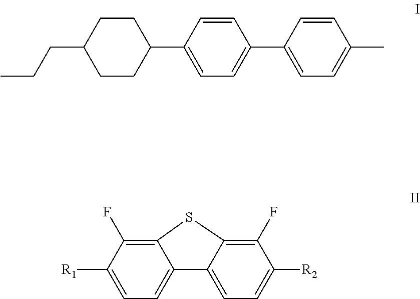
in formula II, R₁ represents an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10; any one —CH₂— or several —CH₂— that are not adjacent of the group indicated by R₁ are selectively substituted by cyclopentyl, cyclobutyl or cyclopropyl;
R₂ represents an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10.

2. The liquid crystal composition according to claim 1, wherein that the liquid crystal composition further comprises one or more compounds of formula III, 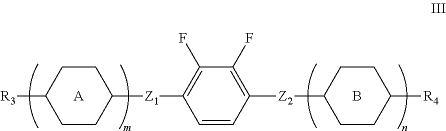
in formula III, R₃ and R₄ independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8, or a fluoro-substituted alkenoxy group having a carbon atom number of 3-8;
any one —CH₂— or several —CH₂— that are not adjacent of the groups indicated by R₃ and R₄ are selectively substituted by cyclopentyl, cyclobutyl or cyclopropyl;
Z₁ and Z₂ independently represent single bond, —CH₂CH₂—, —OCH₂— or —CH₂O—; 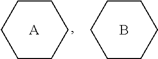
independently represent 1,4-cyclohexylidene, 1,4 cyclohexenylene, 1,4-phenylene or fluoro 1,4-phenylene;
m represents 0 or 1; n represents 0, 1 or 2.

3. The liquid crystal composition according to claim 2, wherein that the compound of formula III is selected from the group consisting of compounds of formula III-1 to III-11: 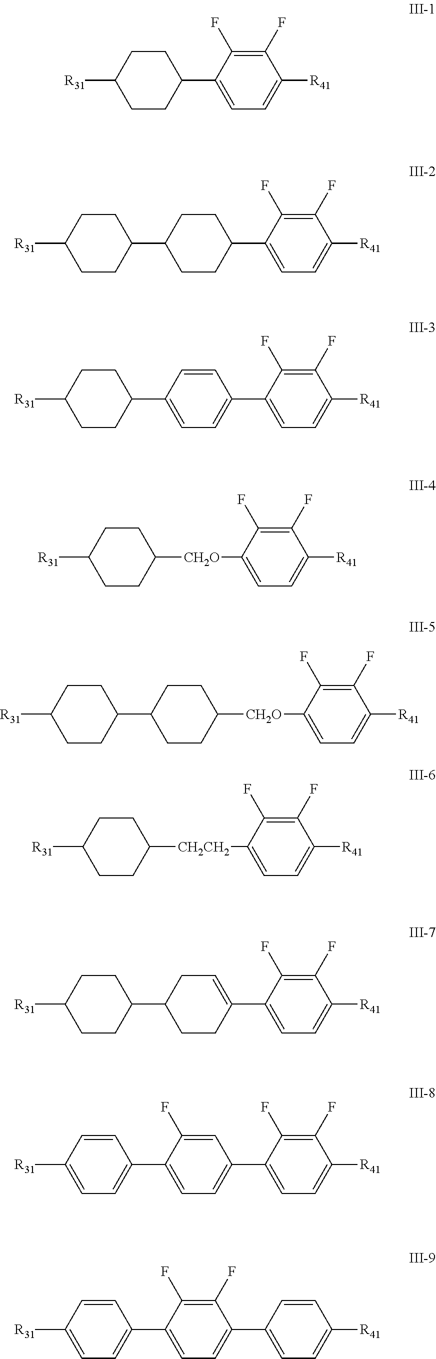 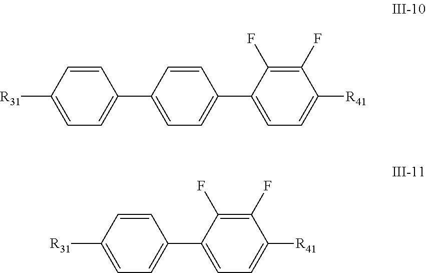
wherein:
R₃₁ and R₄₁ independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, a fluoro-substituted alkenyl group having a carbon atom number of 2-10, an alkenoxy group having a carbon atom number of 3-8, or a fluoro-substituted alkenoxy group having a carbon atom number of 3-8;
any one —CH₂— or several —CH₂— that are not adjacent of the groups indicated by R₃₁ and R₄₁ are selectively substituted by cyclopentyl, cyclobutyl or cyclopropyl.

4. The liquid crystal composition according to claim 1, wherein that the liquid crystal composition also comprises one or more compounds of formula IV: 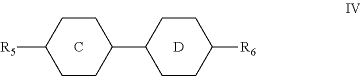
in formula IV, R₅ and R₆ independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, or fluoro-substituted alkenyl group having a carbon atom number of 2-10; 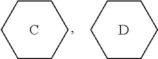
independently represent 1,4-cyclohexylidene, 1,4 cyclohexenylene or 1,4-phenylene.

5. The liquid crystal composition according to claim 4, wherein that the compound of formula IV is selected from the group consisting of compounds of formula IV-1 to IV-3: 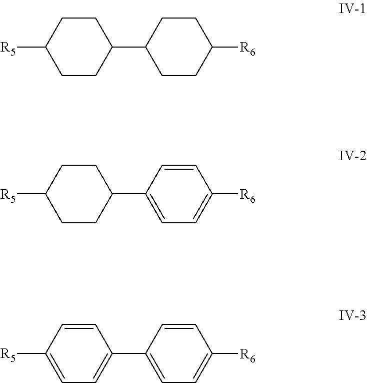
wherein,
in formulas IV-1-IV-3, R₅ and R₆ independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, or a fluoro-substituted alkenyl group having a carbon atom number of 2-10.

6. The liquid crystal composition according to claim 1, wherein that the liquid crystal composition also comprises one or more compounds of formula V except for those compounds of formula I: 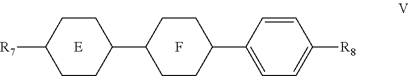
in formula V, R₇ and R₈ independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, or a fluoro-substituted alkenyl group having a carbon atom number of 2-10; 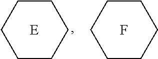
independently represent 1,4-cyclohexylidene, 1,4-cyclohexenylene or 1,4-phenylene.

7. The liquid crystal composition according to claim 6, wherein that the compounds of formula V except for those compounds of formula I are selected from the group consisting of compounds of formula V-1 to V-3: 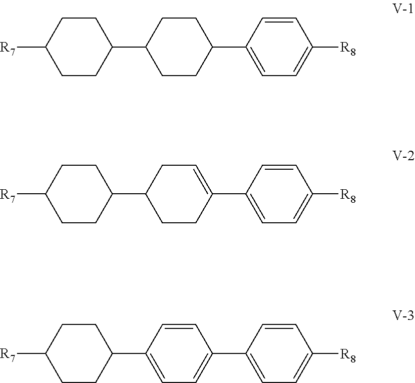
wherein,
R₇ and R₈ independently represent an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, an alkenyl group having a carbon atom number of 2-10, or a fluoro-substituted alkenyl group having a carbon atom number of 2-10.

8. The liquid crystal composition according to claim 1, wherein that the liquid crystal composition also comprises one or more compounds of formula VI: 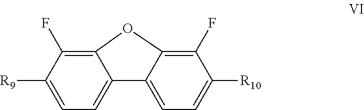
in formula VI, R₉ represents an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10, any one —CH₂— or several —CH₂— that are not adjacent of the group indicated by R₉ are selectively substituted by cyclopentyl, cyclobutyl or cyclopropyl;
R₁₀ represents an alkyl group having a carbon atom number of 1-10, a fluoro-substituted alkyl group having a carbon atom number of 1-10, an alkoxy group having a carbon atom number of 1-10, a fluoro-substituted alkoxy group having a carbon atom number of 1-10.

9. The liquid crystal composition according to claim 8, wherein that the compounds of formula VI are selected from the group consisting of compounds of formula VI-1 to VI-6: 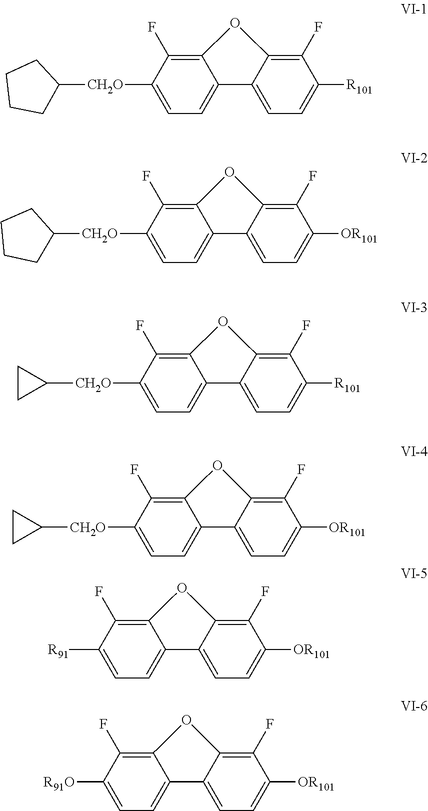
wherein, R₉₁ and R₁₀₁ independently represent an alkyl group having a carbon atom number of 1-10.

10. A liquid crystal display element or liquid crystal display-, wherein that the liquid crystal display element or liquid crystal display comprises the liquid crystal composition of claim 1, the liquid crystal display element or liquid crystal display is an active matrix display element or display or a passive matrix display element or display.
